(19) United States
(12) Patent Application Publication
(10) Pub. No.: US 2013/0026856 A1
(43) Pub. Date: Jan. 31, 2013

(54) Electrical disconnect assembly with separate disconnect compartment, such that safety handle mechanism does not provide access to the disconnecting device or any energized parts or conductors.

(71) Applicant: Bruce William Grindeland, Franklin, WI (US)

(72) Inventor: Bruce William Grindeland, Franklin, WI (US)

(21) Appl. No.: 13/190,337

(22) Filed: Jul. 25, 2011

(51) Int. Cl. F16P 3/20

(52) U.S. Cl. 307/328

(57) ABSTRACT

An electrical disconnect assembly with separate disconnecting device compartment, such that safety handle mechanism does not provide access to the disconnecting device or any energized parts or conductors consisting of multiple compartments arranged so as to allow service of the load compartment without exposure to line voltages. The assembly includes a plurality of compartments with the load compartment having a lockable handle operator that that is interlocked with its corresponding compartment door. The handle operators are mechanically connected to the disconnecting devices via flexible cables or mechanical linkage. A key feature/distinction of this invention is that the disconnecting devices is remote mounted from the overcurrent protective device, so that when the handle operator is switched to the OFF position there are no components (e.g. disconnecting device and/or its conductors) within the load compartment that remain energized by line voltage.

### CROSS-REFERENCE TO RELATED APPLICATIONS

This system/assembly I have described can be used in the way I described a previous provisional patent(s) which I, Bruce William Grindeland, have filed (Application No. 61/367,923 EFS ID: 8095378). This system/assembly also utilizes some concepts similar to those of a non-provisional patent application I have filed (application Ser. No. 12/949,778, Filing or 371(c) Date Nov. 18, 2010).

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

The present invention relates generally to electrical systems, and more particularly, to disconnect assemblies with overcurrent protective devices which protect downstream device(s).

Herein, we refer to “line-voltage” as greater than 50 volts and in typical application, less than 600 volts. When the terms “line side” and “load side” are used they are meant to express the following; line side refers to the termination side of a device that is closest, in terms of electrically circuitry but not necessarily proximity, to the service voltage source (when juxtaposed to what is here referred to as the load side), similarly load side refers to the termination side of a device that is further, in terms of electrical circuitry but not necessarily proximity, to the service voltage source (when juxtaposed to what is here referred to as the line side).

Commonly, all components of such a system are installed in a single enclosure and usually as a single device such that the line and load side of the device are simultaneously exposed from a single access and the line side of the overcurrent protective device remains energized when the compartment is granted access from switching the devices operator to the OFF position. Such an arrangement necessitates de-energizing the entire enclosure for service or adjustment of a single component when following safety procedures and regulations. Federal safety regulations require de-energizing enclosures containing voltages of 50 volts and higher except in specific exceptional situations. De-energizing the entire enclosure is problematic in those applications that require energy to be removed by contacting the electrical service provider or de-energizing a more encompassing feeder upstream.

It would therefore be desirable to design a disconnect assembly that has the line and load side of the overcurrent protective device de-energized when the operating mechanism granting access to the compartment is in the OFF position.

### BRIEF SUMMARY OF THE INVENTION

An electrical disconnect assembly with separate disconnecting device compartment, such that safety handle mechanism does not provide access to the disconnecting device or any energized parts or conductors, consisting of multiple compartments arranged so as to allow service of overcurrent protective device without exposure to line voltages. The assembly includes a plurality of compartments with separate access for at minimum the disconnecting and the overcurrent protective devices. Overcurrent compartment including a lockable handle operator that that is interlocked with its corresponding compartment door. The handle operators are either integral to the disconnect (e.g. circuit breakers, non-trip disconnect, or the like) and directly accessible from the outside of the devices compartment, or are mechanically connected to the load disconnect via flexible cables, mechanical linkage. A key feature and distinction of this invention is that the disconnecting device is segregated from the overcurrent protective device. Thus, when the handle operator is switched to the OFF position, access is granted to the overcurrent protective device which in this state now contains no components (i.e. not even the load side and/or its supply conductors) energized by line voltage. The assembly is constructed of an overall enclosure housing that contains within it a plurality of compartments, one or more compartments for the disconnecting device, and additional separate compartment(s) for the overcurrent protective device(s).

### BRIEF DESCRIPTION OF THE DRAWING

The Drawing demonstrates one solution for a preferred embodiment of the described invention.

Displayed in the drawings:

The Drawing is a diagrammatic view of the overall enclosure, the arrangement of the components, and the interconnection of these components.

### DETAILED DESCRIPTION OF THE INVENTION

The following description makes reference to line voltage. It is appreciated that such a term may refer to a variety of both common voltage ranges and unique voltages depending on context. However, it is appreciated that the present invention is intended for use in typical low-voltage (<600V) electrical systems and the purpose of the invention is to simplify compliance with safety regulations and procedures during maintenance. A typical example would consist of a system wherein supply voltage is 480 volts 3-phase.

Referring to the Drawing, a typical arrangement of the components in a preferred embodiment of the invention is shown. The overall enclosure contains within it a disconnecting device and overcurrent protective device as commonly used in applications of electrical systems. Components include the disconnecting device, mechanical linkage or flexible cable, an operating handle, and an overcurrent protective device. The manner in which the devices are segregated into the separate compartments is crucial to the assembly of my invention.

The general appearance of the invention is similar to that of a common disconnect assembly. However, there are important and distinct differences between the present invention and existing disconnect assembly designs.

Disconnect assemblies typically include a circuit disconnecting device with an integral overcurrent protective device or accommodations for replaceable overcurrent protections (e.g. fuses) all contained within a single overall enclosure. Energized conductors enter the enclosure and connect to the line side of the internal disconnecting device. The disconnect includes a handle operator that interlocks with disconnecting device (e.g. circuit breaker) that is located within the enclosure. When the handle is moved to the OFF position a door interlock allows access to the inside of the enclosure. A hazard exists within the enclosure, which the door interlock has granted access to, contains parts energized at line voltage even when the handle is in the OFF position. Safety procedures and regulations do not allow working within a enclosure that contains parts energized at 50 volts or higher other than specific exceptional situations.

The disconnect enclosure of the present invention is distinctly different from existing; I will expound upon the differences and improvements.

The first distinction is that in the preferred embodiment of my invention the disconnecting device is mounted in a separate compartment from the overcurrent protective device (which is mounted in the “load compartment”). While the disconnecting device is operated by the handle operator that is interlocked with the load compartment door, this handle position does not grant access to the disconnect compartment door. This feature eliminates the existence of energized line voltage parts within the compartment that is granted access to, the load compartment in this case, when the handle is switched to the OFF position. The incoming power conductors come from the load side of the disconnecting device so that when the disconnect is in the OFF position, there are no energized conductors or terminals that are granted access to by the door interlock of the load compartment.

Secondly, in the preferred embodiment of my invention; where there is a fuse(s) serving as the overcurrent protective device; both the line side and load side terminals for the fuse(s) are de-energized when the load compartment is granted access to by the handle operator that operates the disconnecting device. By doing this, overcurrent protective devices can be easily serviced in completely de-energized compartments.

It is a purpose of my invention to simplify compliance with safety regulations, thereby encouraging compliance.

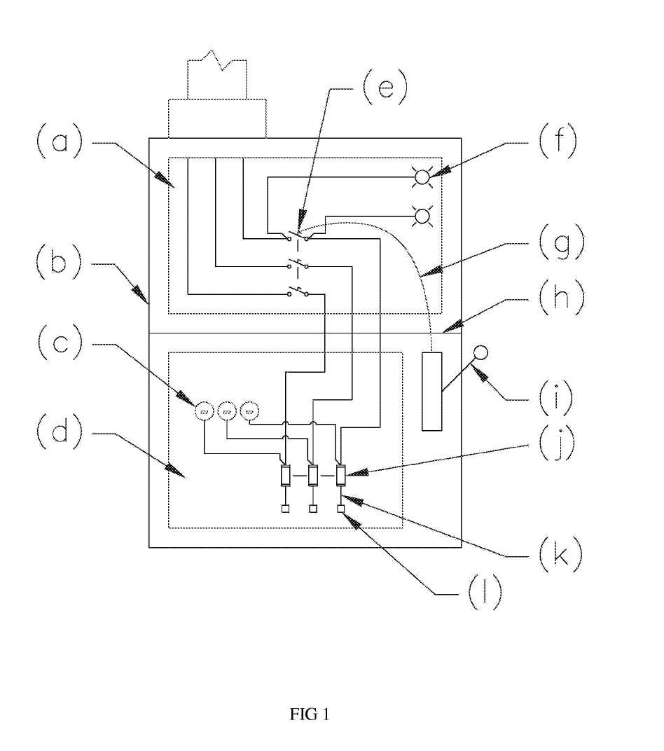

Referring again to the Drawing, FIG. 1, assume it is necessary to perform maintenance to or replace a overcurrent protective device being fed power through the disconnect. The technician switches the disconnect handle to the OFF position. The technician then can open the load compartment door. Following standard safety procedures the technician then verifies that the conductors are de-energized and can now service the device. At this point he can perform his work without concern of violating regulations as the compartment he is working in is completely de-energized of all voltage. This scenario is in many cases simpler and/or less disruptive to de-energizing the upstream service disconnect.

Referring to the Drawing, FIG. 1, we see a diagrammatic view representing a preferred embodiment of my invention. I will here describe, in more detail, the arrangement of the components in reference to the provided drawing;

Referring again to FIG. 1, (a) is the space that is herein referred to as the disconnect compartment. This is the compartment which houses the disconnecting device and optionally indicators that would be illuminated on voltage present respective to the line and load side of the disconnecting device. This is the compartment where the power feeding the circuit is brought into and where power feeds from for the load compartment.

Referring again to FIG. 1, (b) is meant to display the overall enclosure. This is the combination of the disconnect compartment and the load compartment. This could be a single enclosure with sub-compartments or a combination of two compartments that combine in the same manner to achieve the same functionality.

Referring again to FIG. 1, (c) is referring to an optional component that are referred to as “non-contact test points”. This component is not crucial to the functionality of my invention but would be an improvement to it.

Referring again to FIG. 1, (d) is the space that is herein referred to as the load compartment. This is the compartment which houses the overcurrent protective device (e.g. fuse(s), circuit breaker, overload or the like). This compartment also optionally houses what are referred to as “non-contact test points”. Devices such as contactors could also be installed in the load compartment.

Referring again to FIG. 1, (e) is referring to the disconnecting device (e.g. non-fused disconnect, rotary disconnect, or the like) which is housed in the disconnect compartment. This is the device which makes or breaks the electrical connection to the load compartment. This device is interlocked with the operator that grants access to the load compartment such that when the disconnecting device is in the OFF state; access is granted to the, now, completely de-energized load compartment. When this device is in the ON state; access is not granted to the load compartment as there are potentially energized components within it.

Referring again to FIG. 1, (f) is referring to the optional component(s) which I will refer to as “voltage present indicators”. This device is not essential for the functionality of my invention is a possible improvement thereof. This device would be connected to the line side and/or the load side of the disconnect such that the indicator would be illuminated when there is power to the side of the disconnect to which it is connected.

Referring again to FIG. 1, (g) is representing an interlocking mechanism (e.g. mechanical linkage, flexible cable, or the like) that operates or interlocks the state of the disconnecting device with the operator handle which grants access to the load compartment.

Referring again to FIG. 1, (h) is representing a barrier that segregates the disconnect compartment from the load compartment. This barrier would preferably be made of metal but could be made of any material that would act as an insulation or protective barrier for line voltages. In the preferred embodiment of my invention this barrier would be integral to the overall enclosure but could potentially be the walls of an upper and lower enclosure which are serving as the disconnect and load compartments.

Referring again to FIG. 1, (i) this component is the operator handle. The operator handle works in conjunction with a door interlock for the load compartment and an interlocking mechanism which connects to the remote disconnecting device. In the preferred embodiment of my invention this device would manipulate the state of the disconnecting device between ON and OFF but could also be interlocked by the state of the disconnecting device such that it is mechanically locked into position based on the state of the disconnecting device. When this device is in the ON position; it should stop access to the load compartment as the disconnecting device should at that time be in the ON or CLOSED state. When this device is in the OFF position; it should grant access to the load compartment as the disconnecting device should at that time be in the OFF or OPEN state.

Referring again to FIG. 1, (j) is intended to represent an overcurrent protective device (e.g. fuse(s), circuit breaker, overload, or the like). This device should have power to it when the external operator handle is in the ON position and likewise the disconnecting device is in the ON or CLOSED state. This device should have power removed from it when the external operator handle is in the OFF position and likewise the disconnecting device is in the OFF or CLOSED state.

Referring again to FIG. 1, (k) is intended to represent typical conductors (e.g. insulated copper wire, bus, or the like) which electrically connect the multitude of components within my invention. These conductors would not necessarily be installed by a factory producing the item but could be for the convenience of a customer. In either case, these conductors would be essential to the functional operation of my invention in the preferred embodiment.

Referring again to FIG. 1, (l) is intended to represent typical lugs (e.g. aluminum lugs, copper lugs, terminals, or the like). This component is not crucial to functional operation of my invention in the preferred embodiment. This device, if included, would serve as a convenience for someone landing conductors on the load side of the preferred embodiment of my invention.
Referring again to FIG. 1, the overall enclosure could be either a single unit which compartmentalizes a plurality of sub-compartments which are here referred to as the disconnect compartment and the load compartment. The sub-compartments could also be stand-alone compartments fashioned together in the arrangement depicted.
Referring again to FIG. 1, the disconnect compartment contains a disconnecting device, conductors as necessary, and mechanical linkage or flexible cable as necessary to interlock with the operator handle. Depicted in the drawing are line/load voltage indicators which are an optional component to this invention. The disconnecting device compartment door or plate would preferably be fastened on or closed in such a way that it would require a screwdriver or other special tool to open.
Referring again to FIG. 1, the load compartment contains the overcurrent protective device(s) (e.g. Fuse(s), Circuit Breaker, overloads, or the like), and an operator handle which is interlocked with the door of the load compartment and switches the remote disconnecting device between its plurality of states (e.g. ON, OFF, etc.)
Referring again to FIG. 1, incoming power is fed into the disconnecting device compartment and terminated on the line side of the disconnecting device, power is continued from the load side of the disconnecting device to the load compartment. The power coming into the load compartment is terminated on the line side of the overcurrent protective device, power is continued from the load side of the overcurrent protective device to that which it feeds power (i.e. it may be terminated on terminals, lugs, or the like within the load compartment and/or continue to the device(s) or system to which it is feeding power.

To manufacture my invention:
The manufacturing entity would mount and wire as necessary the appropriate devices for each of the following aspects of the electrical disconnect assembly within their respective compartments, while following the necessary guidelines that I have previously laid out within this document (e.g. mounting the disconnecting device in a separate compartment from that of the overcurrent protective device).
   Disconnecting devices
   Enclosure
   Doors and cover plates as necessary
   Overcurrent protective device(s)
   Other Devices, as necessary (e.g. auxiliary contacts, voltage testing terminals, conductors, mechanical linkage, and the like)
Components and methods such as; through-wall disconnect operators, interlocking handles, interlocked auxiliary contacts, doors and covers with appropriate gaskets, and the like should be used so that the integrity of isolating the compartments, from each other and a person standing in front of the system, remains in tact.
The compartments should be arranged in such a way to allow for operation and interaction of the complete system in the mode that I have described within this document.
In the preferred embodiment of my invention; all of the individual compartments would be arranged and/or mounted within an overall enclosure or arranged in such a way as to carry out the same operation in the way that I have previously described.
When manufacturing in volume, a complete single enclosure which includes all of the same separation by barriers and various doors and covers could be made to reduce costs and materials used for a specific configuration.
In smaller volumes use of separate enclosures installed within an overall housing is more flexible.

I have herein described the preferred embodiment of the present invention in one form that would be useful for electrical disconnect assemblies as would be used in electrical circuits. The specific arrangement would may vary depending on the “size” of the service, project specific requirements, and desired optional features. It is recognized that equivalents, alternatives, and modifications, aside from those expressly stated, are possible and within the scope of the appending claims.

What I claim as my invention is:

1. An electrical disconnect assembly with separate disconnecting device compartment, such that safety handle mechanism does not provide access to the disconnecting device or any energized parts or conductors, consisting of multiple compartments arranged so as to allow service of or access to the load compartments without exposure to line voltages.

2. The electrical disconnect assembly with separate disconnecting device compartment, such that safety handle mechanism does not provide access to the disconnecting device or any energized parts or conductors of claim 1 wherein the disconnecting device(s) (e.g. circuit breakers, or non-trip disconnects) is compartmentalized separately from the overcurrent protective device(s), so as to have no line voltages present in the load compartment when disconnecting device is open.

3. The electrical disconnect assembly with separate disconnecting device compartment, such that safety handle mechanism does not provide access to the disconnecting device or any energized parts or conductors of claim 1 wherein the disconnect handle interlocks with the load compartment door to prevent access to the load compartment when the corresponding handle is in the ON position, as the load compartment may be energized by the remote disconnect unit in this state.

4. The electrical disconnect assembly with separate disconnecting device compartment, such that safety handle mechanism does not provide access to the disconnecting device or any energized parts or conductors of claim 1 wherein the disconnect handle interlocks with the load compartment door to grant access to the motor controller compartment when the handle is in the OFF position, as the compartment is de-energized by the disconnecting device in this state.

5. The electrical disconnect assembly with separate disconnecting device compartment, such that safety handle mechanism does not provide access to the disconnecting device or any energized parts or conductors of claim 1 wherein the modular compartments are contained within an overall enclosure or arranged in a fashion that accomplishes the same functionality that I have described.
